(19) United States
(12) Patent Application Publication
(10) Pub. No.: US 2018/0304512 A1
(43) Pub. Date: Oct. 25, 2018

(54) DEVICE FOR TRANSFER AND/OR HANDLING AND TRANSPORT OF WORKPIECES

(71) Applicant: WITTMANN KUNSTSTOFFGERAETE GMBH, Wien (AT)

(72) Inventors: Peter Michael WITTMANN, Leobendorf (AT); Johannes RELLA, Payerbach (AT)

(73) Assignee: WITTMANN KUNSTSTOFFGERAETE GMBH, Wien (AT)

(21) Appl. No.: 15/769,572

(22) PCT Filed: Oct. 12, 2016
(86) PCT No.: PCT/AT2016/000089

§ 371 Date: Apr. 19, 2018

(30) Foreign Application Priority Data
Oct. 21, 2015 (AT) A 683/2015

(51) Int. Cl. B29C 45/76; B29C 45/42; B25J 13/08; B25J 15/06; B25J 19/02

(52) U.S. Cl. CPC B29C 45/7626; B29C 45/4225; B25J 13/086; B25J 15/0616; B25J 19/022; B29C 2945/76993; B29C 2945/76096; B29C 2945/76461; B29C 2945/76581; B29C 2945/76795; B29C 2045/7633

(57) ABSTRACT

The invention relates to a device for handling and/or transporting workpieces (5), in particular for removal of injection-molded items from an injection-molding machine, wherein a handling robot (4) having a programmable control and regulating unit (10) is provided that comprises a gripper (6) having at least one suction nozzle (7) for grasping of the workpiece (5) or fixating it by suction. In the gripper (6) of the handling robot (4) a distance-measuring device (8) for detection of the distance (a₁₊a₂) from the gripper (6) to a reference point or a reference surface (9), for example to the mold tool half (2), which is preferably movable, with the workpiece (5), is provided. The measured value of the distance-measuring device (8) is fed into the control and regulation unit (10). The distance-measuring device (8) can be a light-transit time measuring device, in particular a time-of-flight (TOF) sensor.

The invention relates to a device for handling and/or transporting workpieces, in particular for removal of injection-molded items from an injection-molding machine, wherein a handling robot having a programmable control and regulating unit is provided that comprises a gripper having at least one suction nozzle for grasping of the workpiece or fixating it by suction.

The problems that occur upon removal of workpieces from an injection mold have been discussed before. Especially older injection-molding machines or machines of Asian design open the injection mold to a slightly different width during each cycle. Similarly, operators of injection-molding machines can change the mold opening position on the control unit in any operating mode. As a result, reliable gripping of the injection-molded part by means of the gripper located on the removal robot cannot be guaranteed. There is even the possibility of a collision between the injection mold and the removal gripper or handling robot.

Thus, from AT 510 154 B1 a device and a method for handling and/or transporting of workpieces, in particular for the removal of injection-molded items from an injection-molding machine, are known. In this method, the suction nozzle is activated when approaching the workpiece, and the negative pressure is continuously or permanently measured. Upon reaching an adjustable or determined threshold value of the negative pressure, the forward movement of the handling robot is stopped, preferably in a braking operation, and the workpiece is fixated by the suction of the suction nozzle.

EP 0 729 405 B1 discloses removal of an optical plate from an injection mold by means of negative pressure. In this document, the main focus is on shortening of the handling time, whereby reduction in mass and shortening of the path for the robot arm are sought.

Furthermore, from WO 2007/010850, a control device for a molding machine is known. Via this control device, the operating mode in which the machine is operated is set and operated on the basis of a defined state of the machine. As described in this document, the productivity of the molded products can thereby be improved.

DE 1 604 598 A2 discloses an apparatus for demolding lightweight moldings, in particular plastic bottles, in which negative pressure is used for removal from the molding tool as well. With this apparatus, demolding without manual handling is to be ensured.

Furthermore, for example from DE 296 06 853 U1 a gripper device for the removal of thin-walled injection-molded parts from an injection molding tool is known, wherein the gripper device is provided with a plurality of suction grippers. This gripper device is intended to avoid unwanted bending, in particular of CD cases.

Finally, from DE 10 2005 061 193 A1 a handling method is known, wherein loading of the machine with production parts from a production part bin by means of a handling device associated with a loading robot takes place.

The serious disadvantage of the methods that work with negative pressure is that measurement of the negative pressure can take place only in the very last part, i.e. shortly before workpiece removal. For this reason, the speed of the gripper during workpiece removal must be selected to be correspondingly slow, as there is a risk that the gripper may damage the mold half.

It is known, as indicated above, that injection-molded items are removed from an injection-molding machine by means of suction nozzles. Especially with older injection-molding machines, the problem arises that the opening stroke is not performed without tolerance, making grasping of the workpiece with the gripper difficult. Inaccurate grasping of the workpiece can lead to production defects or production stoppages. Likewise, inaccurate grasping during handling of injection-molded items via suction nozzles, for example when dismantling a buffer stack, leads to disturbances in the production workflow.

The objective of the invention is therefore to provide a method of the type mentioned above that on the one hand avoids the above disadvantages and on the other hand increases the overall economic viability of the system.

The problem is solved by the present invention.

The device according to the invention is characterized in that in the gripper of the handling robot a distance-measuring device for detection of the distance from the gripper to a reference point or a reference surface, for example to the mold half, which is preferably movable, with the workpiece is provided, and that the measured value of the distance-measuring device is fed into the control and regulation unit. With the invention, it is now possible for the first time to move the gripper for the removal movement, i.e. when approaching the workpiece, much more rapidly, since the measurement of the distance from the mold half, i.e. a reference point or a reference surface, to the suction nozzle can take place already after entry of the gripper into the opening area of the mold. The starting point of the measurement can thus be extended immensely by the approach path, which optionally allows a higher initial speed or a longer movement of the gripper at high speed. As a result, the total speed for removal is considerably increased, which of course contributes to the rational efficiency of the system in relation to the solutions according to the prior art. Furthermore, the mold and the workpiece are “found” precisely and handled gently. The movement of the handling robot, also called the demolding axis, is controlled by the measured value from the distance-measuring device, which is fed to the control and regulation unit.

The distance-measuring device is provided directly in the gripper, so that the latter can be moved permanently with optimized and maximum removal speed to the determined removal position.

According to a special feature of the invention, the distance-measuring device is a light-transit time measuring device, in particular a time-of-flight (TOF) sensor. Such sensors are so cheaply available on the market that for each product, and thus for each gripper, the sensor or sensors fixated in the gripper can be exchanged. The control and regulation unit can be firmly attached to the handling robot via a connection. The product change can also be carried out more quickly, since the TOF sensor is already arranged on the gripper.

According to an alternative feature of the invention, the distance-measuring device is a laser measurement device that measures according to the triangulation principle. According to this principle, a light beam falls on the reference surface at a slight angle and is reflected at an acute angle, thereby re-entering the sensor at a point slightly offset from the starting point. The distance is then calculated using triangular geometry. In addition to eliminating the product-dependent adjustment of the sensor, the measurement accuracy can be increased thereby. By the laser moving with the gripper towards the open mold plate, the path to be measured is shortened. The resolution can therefore be increased, with the value range remaining constant, relative to a maximum distance reduced gradually.

According to a particular embodiment of the invention, the connection from the distance-measuring device to the control and regulation unit is a wireless data connection, wherein the sensor board of the TOF sensor is supplied with a battery. This eliminates the need for a cable connection from the distance measuring device to the control and regulating unit, whereby exchange of the gripper is very much simplified. In addition, one source of errors or malfunctions during operation is avoided by the wireless connection.

According to a particular alternative embodiment of the invention, the connection from the distance-measuring device to the control and regulation unit is a wireless data connection, wherein the sensor board of the TOF sensor is supplied based on energy harvesting or kinetic energy harvesting. Both the connection based on energy harvesting and the connection based on kinetic energy harvesting are wireless. The advantages of such a connection are evident.

It is also an objective of the invention to provide a method for handling and/or transporting workpieces, in particular for the removal of injection-molded items from an injection-molding machine, using a device according to the above description.

The method according to the invention is characterized in that when the gripper approaches the workpiece, the distance-measuring device is or has been activated, and the distance and/or the path until the workpiece is grasped or fixated by suction, respectively, is measured continuously or permanently, and the measured value is fed into the programmable control and regulating unit, and upon reaching an adjustable or determined distance and/or path, the forward movement of the handling robot is stopped, preferably in a braking operation, and the workpiece is fixated by the suction of the suction nozzle. The method according to the invention is based on the distance or the path being measured when the gripper approaches the workpiece. The distance is measured continuously or permanently. Upon reaching an adjustable value of the distance, the movement of the handling robot is slowed down via the control and regulation unit, namely until it stops when touching the workpiece. Due to the preprogrammed braking path of the handling robot, upon its standstill the suction nozzle touches the workpiece which can then be fixated by the suction for transport. The demolding stroke or the gripping of the workpiece is thus not tied to any fixed position of the injection molding tool. Thanks to this flexible, but accurate, approach of the gripper or the suction nozzle to the workpiece, the likelihood of damage to the workpiece by excessive pressure or poor grasping is minimized. In reality, the suction nozzle can tolerate up to about 5 mm of play, too.

Of course, it is also within the scope of the invention to use the method according to the invention for “finding” the parts when unstacking from a workpiece buffer or “finding” the storage position on a stack, or the like.

According to one feature of the invention, the forward movement or the braking operation, respectively, takes place at a delayed speed up to the stop. As already mentioned, it is of course advantageous if the speed of the handling robot is slowed down before the contact of the suction nozzle with the workpiece.

According to a particular embodiment of the invention, for programming the control and regulating unit of the handling robot, the basic parameters, such as, for example, transfer distance or removal distance, opening path of the injection-molding machine are empirically determined and entered via a teaching method (teach-in) and for example size, shape, position and surface structure of the workpiece. By incorporating these factors, also to be seen as a calibration, the method is applicable individually and to virtually all types of injection-molding machines.

The invention will be explained in more detail by reference to an embodiment, which is illustrated in the drawing.

Wherein:

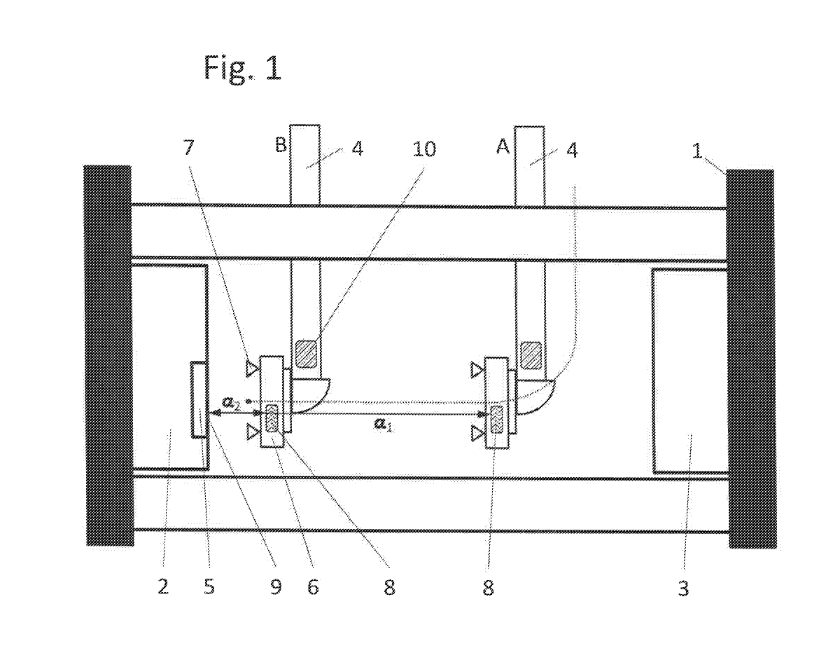

FIG. 1 schematically shows a tool room of an injection-molding machine with the handling robot and

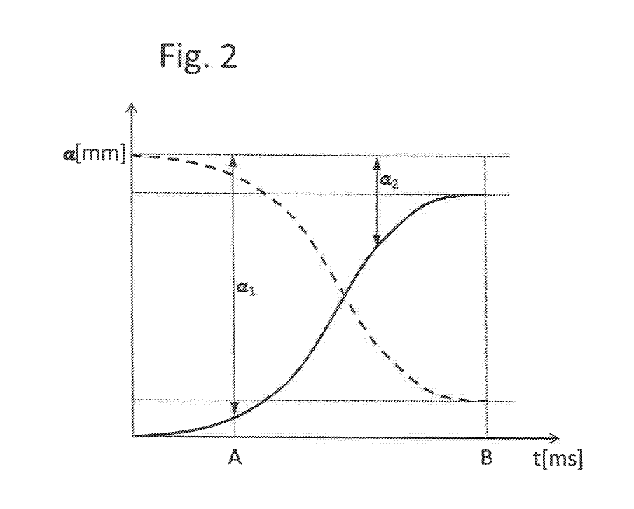

FIG. 2 is a diagram of the removal process of the handling robot.

According to FIG. 1, an injection-molding machine 1 with the open molding tool halves 2, 3 is shown. A handling robot 4 is moved into the open tool halves 2, 3 for the removal of a workpiece 5. The position A of the handling robot 4 is the entry into the open mold, wherein in position A the handling robot 4 has already reached the point for the release of the measurement onto the reference surface 9.

In position B, the handling robot 4 is in the area of the workpiece 5.

The handling robot 4 is movable with a motor that can be acted upon via a programmable control and regulation unit. The handling robot 4 is provided with a gripper 6 and at least one suction nozzle 7. In the handling robot 4, a programmable control and regulation unit 10, optionally with an independent sensor evaluation unit, is provided.

In the gripper 6 of the handling robot 4, a distance-measuring device 8, e.g. the TOF sensor, for detection of the distance a₁₊a₂ from the gripper 6 to a reference point or a reference surface 9, for example to the mold tool half 2, which is preferably movable, with the workpiece 5, is provided. The measured value a₁₊a₂, i.e. the distance from the reference surface 9 to the distance-measuring device 8 of the entering handling robot 4 in position A, is fed into the control and regulation unit 10.

The distance-measuring device 8 can be a light-transit time measuring device, in particular a time-of-flight (TOF) sensor.

An alternative solution would be to implement the distance measuring device 8 as a laser measurement device that measures according to the triangulation principle.

The connection from the distance measuring device 8 to the control and regulation unit 10 or the sensor evaluation unit is preferably a wireless data connection, wherein the sensor board of the TOF sensor is supplied with a battery. As an alternative, elegant solution, the connection from the distance measuring device 8 to the control and regulation unit 10 could be a wireless data connection, wherein the sensor board of the TOF sensor is supplied based on energy harvesting or kinetic energy harvesting.

When the gripper 6 approaches the workpiece 5, the suction nozzles 7 are activated. The closer the suction nozzles 7 approach the workpiece, the smaller the distance a₁ becomes. This distance a₁₊a₂ is continuously or permanently measured, and upon reaching an adjustable or determined threshold value of the distance a₁, for example at the distance a₂, the forward movement of the handling robot 4 is stopped, preferably in a braking operation. When the suction nozzles 7 touch the workpiece 5, the workpiece 5 is fixated by the suction of the nozzles 7.

The distance a₁₊a₂ can be measured at an interval of 4 milliseconds. Here the measurement of the distance a₁₊a₂ could be performed analogously, where this measured value is digitized for processing already in the sensor or in the control and regulation unit 10.

Of course, the forward movement or the braking operation after reaching the threshold value can be carried out at a delayed speed up to the stop.

For programming the control and regulating unit of the handling robot 4, the basic parameters, such as, for example, transfer distance or removal distance, opening path of the injection-molding machine are empirically determined and entered for the threshold value via a teaching method (teach-in) and size, shape, position and surface structure of the workpiece 5.

According to FIG. 2, in a diagram on the one hand—with a continuous line—the path s of the handling robot 4 over time t, and on the other—with a dotted line—the distance a over time is shown.

The diagram shows that in the entry phase A of the handling robot 4 in the mold opening, the distance-measuring device 8 starts measuring. In addition, the path is covered very quickly. In this area, the suction nozzles 7 are not yet activated, but are approaching the workpiece 5. Of course, the suction nozzles could be activated earlier as well.

In position A, the suction nozzles 7 are activated, the measurements begin, and the distance a₁ approaches the selected target value a₂. Preferably from the threshold value or at most from position A, the gripper 6 approaches the workpiece 5 at reduced speed.

Approximately in position B, the suction nozzles 7 or the gripper 6, respectively, further approach the workpiece 5, and the distance a₂ is reached. If this value is used or defined as a threshold value, the braking operation of the handling robot 4 starts here. The negative pressure of the suction nozzles 7 can of course increase towards the removal process. Due to the delayed speed until it stops, gentle removal is ensured.

1. Device for handling and/or transporting workpieces, in particular for the removal of injection-molded items from an injection-molding machine, wherein a handling robot having a programmable control and regulating unit is provided that comprises a gripper having at least one suction nozzle for grasping of the workpiece or fixating it by suction, characterized in that in the gripper (6) of the handling robot (4) a distance-measuring device (8) for detection of the distance (a1+a2) from the gripper (6) to a reference point or a reference surface (9), for example to the mold half (2), which is preferably movable, with the workpiece (5), is provided, and that the measured value of the distance-measuring device (8) is fed into the control and regulation unit (10).

2. Device according to claim 1, characterized in that the distance-measuring device (8) is a light-transit time measuring device, in particular a time-of-flight (TOF) sensor.

3. Device according to claim 1, characterized in that the distance-measuring device (8) is a laser measurement device that measures according to the triangulation principle.

4. Device according to claim 1, characterized in that the connection from the distance-measuring device (8) to the control and regulation unit (10) is a wireless data connection, wherein the sensor board of the TOF sensor is supplied with a battery.

5. Device according to claim 1, characterized in that the connection from the distance-measuring device (8) to the control and regulation unit (10) is a wireless data connection, wherein the sensor board of the TOF sensor is supplied based on energy harvesting or kinetic energy harvesting.

6. Method for handling and/or transporting workpieces, in particular for the removal of injection-molded items from an injection-molding machine, using a device according to claim 1, characterized in that when the gripper (6) approaches the workpiece (5), the distance-measuring device (8) is or has been activated, and the distance (a1, a2) and/or the path until the workpiece (5) is grasped or fixated by suction, respectively, is measured continuously or permanently, and the measured value is fed into the programmable control and regulating unit (10), and upon reaching an adjustable or determined distance (a2) and/or path, the forward movement of the handling robot (4), is stopped, preferably in a braking operation, and the workpiece (5) is fixated by the suction of the suction nozzle (7).

7. Method according to claim 6, characterized in that the forward movement or the braking operation takes place at a delayed speed up to the stop.

8. Method according to claim 6, characterized in that for programming the control and regulating unit (10) of the handling robot (4), the basic parameters, such as, for example, transfer distance or removal distance, opening path of the injection-molding machine are empirically determined and entered via a teaching method (teach-in) and for example size, shape, position and surface structure of the workpiece (5).
